(19) United States
(12) Patent Application Publication
(10) Pub. No.: US 2018/0217591 A1
(43) Pub. Date: Aug. 2, 2018

(54) DRONE SECURITY AND ENTERTAINMENT SYSTEM

(71) Applicant: Bennett Aerospace, Inc., Cary, NC (US)

(72) Inventors: Matthew Wiggins, Cary, NC (US); Julia Bennett, Cary, NC (US); Douglas Bennett, Cary, NC (US); Mackenzie Dougherty, Cary, NC (US); Willis Herweyer, Cary, NC (US)

(21) Appl. No.: 15/883,466

(22) Filed: Jan. 30, 2018

Related U.S. Application Data
(60) Provisional application No. 62/453,732, filed on Feb. 2, 2017.

(51) Int. Cl. G05D 1/00; H04B 7/185; H04N 7/14; H04N 7/18; B64C 39/02

(52) U.S. Cl. CPC G05D 1/0038; H04B 7/18506; H04N 5/23216; H04N 7/185; B64C 39/024; H04N 7/14

(57) ABSTRACT

A method of operating a drone security and entertainment system includes: engaging a drone with a base; receiving signals from at least one sensor remote from the drone vehicle and base; detecting activity; disengaging the drone vehicle from the base; traveling by the drone vehicle; collecting, by the drone vehicle, data including at least one of video, audio, and sensor data; and transmitting, by the drone, the collected data. A security system includes: a base configured to house and charge a drone vehicle; a drone vehicle configured to engage with the base; and at least one sensor in electrical communication with the drone vehicle, wherein the drone is configured for: receiving signals from the at least one sensor; detecting activity; disengaging from the base; traveling; collecting data including at least one of video, audio, and sensor data; and transmitting the collected data.

### CROSS-REFERENCE TO RELATED APPLICATION

This application claims the benefit of priority of U.S. provisional patent application No. 62/453,732, titled “DRONE SECURITY AND ENTERTAINMENT SYSTEM,” filed on Feb. 2, 2017, which is incorporated herein in its entirety by this reference.

### TECHNICAL FIELD

The present disclosure relates to a drone system that provides an autonomous and responsive deterrent to crime while also providing active, guidable remote surveillance for homes, businesses and government installations, for less cost than other systems.

### BACKGROUND

Passive camera systems are available with video recording and/or constant human monitoring. Passive alarm systems wait for entry breach as indicated by sensor signals. Some systems activate simple flood lights that illuminate when motion is detected.

Many existing systems are either too expensive or are not active in their deterrence of crime. For example, systems that require a human to monitor video or data feeds at all times is cost prohibitive to many homeowners, small business owners, and other entities. A thief may see a stationary fixed camera system and simply circumventing the defense by avoiding the view area of the camera. A thief may not believe anyone is really watching video feeds or otherwise monitoring sensor signals.

Improvements in security systems and methods that provide an active deterrent and real-time responses demonstrating active monitoring for reasonable costs are needed.

### SUMMARY

This summary is provided to introduce in a simplified form concepts that are further described in the following detailed descriptions. This summary is not intended to identify key features or essential features of the claimed subject matter, nor is it to be construed as limiting the scope of the claimed subject matter.

In at least one embodiment, an active drone launches automatically upon detection of activity, navigates to an area of detected motion, and plays a pre-recorded announcement as an active deterrent that is a fraction of the cost of constant human monitoring.

In at least one embodiment, a method of operating a drone security system includes: engaging a drone with a base; receiving signals from at least one sensor remote from the drone vehicle and base; detecting activity; disengaging the drone vehicle from the base; traveling by the drone vehicle; collecting, by the drone vehicle, data including at least one of video, audio, and sensor data; and transmitting, by the drone, the collected data.

In at least one example, detecting activity includes receiving a user command signal prompted by activity of a user at a user interface.

In at least one example, transmitting the collected data includes streaming video to the user interface for viewing by the user.

In at least one example, traveling by the drone vehicle includes at least intermittently traveling according to user command signals.

In at least one example, detecting activity includes determining unrecognized activity via the received signals from the at least one sensor.

In at least one example, traveling by the drone vehicle includes traveling to a location of the detected activity.

In at least one example, traveling by the drone vehicle includes flying.

In at least one embodiment, a security system includes: a base configured to house and charge a drone vehicle; a drone vehicle configured to engage with the base; and at least one sensor in electrical communication with the drone vehicle, wherein the drone is configured for: receiving signals from the at least one sensor; detecting activity; disengaging from the base; traveling; collecting data including at least one of video, audio, and sensor data; and transmitting the collected data.

In at least one embodiment, the drone vehicle will be preset with a set of parameters by the user and it will fly autonomously to a location where activity is detected.

At least one example includes a weather station that collects weather data (wind, precipitation, temperature) for use as wall as well as motion detection. The weather data is received by the base and transmitted via Wi-Fi or other method to the drone. The drone, based on input from the base station, may then decide to fly or not, and decide on a specific location to monitor based on criteria set up by the owner or user.

In addition to practical security applications, the security drone may have entertainment value. The user has the ability to create a security drone personality to display user-created images and sounds during deployment and movement (music may play, a voice may speak a warning or greeting, a barking dog sound may be played). The user has the ability to converse through the drone. The drone security and entertainment system's base will be a drone hangar that includes an external shell that will protect the vehicle and any hardware needed to open the hangar to release the drone. The hangar will include a drone charging mechanism that will charge the drone battery without separation from the vehicle body and will automatically begin charging when the drone lands. The hangar will include integral sensors for temperature, wind, humidity, air quality, precipitation, battery health, and signal strength. For the sensors, charger and enclosure, a small integral computer will be included. Software for the hangar computer will run a collection of programs that will monitor the motion detection modules and analyze the data from the sensors to determine suitability of launch parameters for the drone. Software may be Ubuntu, Robot Operating System, and customer programs may be in Python.

### BRIEF DESCRIPTION OF THE DRAWINGS

The previous summary and the following detailed descriptions are to be read in view of the drawings, which illustrate particular exemplary embodiments and features as briefly described below. The summary and detailed descriptions, however, are not limited to only those embodiments and features explicitly illustrated.

FIG. 1 shows an unmanned vehicle (UMV) referenced herein as a drone, according to at least one embodiment.

FIG. 2A is a perspective view of a base for the drone of FIG. 1, according to at least one embodiment, shown in an open configuration.

FIG. 2B is a perspective view of the base of FIG. 2A, shown with a door thereof in a closed configuration.

FIG. 2C is a perspective view of the drone of FIG. 1 shown hangered in the base of FIG. 2A.

FIG. 3 shows a mobile computing device for use in monitoring and controlling the drone of FIG. 1 and optionally base of FIGS. 2A-2C.

FIG. 4 is a diagrammatic representation of an in-use security system, according to at least one embodiment, having at least one each of the drone, base and mobile device of FIGS. 1, 2A and 3 respectively.

FIG. 5 is a flow chart representation of a method of operating a drone security system according to at least one embodiment.

FIG. 6 is a diagrammatic representation of a computing device of which the mobile device of FIG. 3 may be an example.

### DETAILED DESCRIPTIONS

These descriptions are presented with sufficient details to provide an understanding of one or more particular embodiments of broader inventive subject matters. These descriptions expound upon and exemplify particular features of those particular embodiments without limiting the inventive subject matters to the explicitly described embodiments and features. Considerations in view of these descriptions will likely give rise to additional and similar embodiments and features without departing from the scope of the inventive subject matters. Although the term “step” may be expressly used or implied relating to features of processes or methods, no implication is made of any particular order or sequence among such expressed or implied steps unless an order or sequence is explicitly stated.

Any dimensions expressed or implied in the drawings and these descriptions are provided for exemplary purposes. Thus, not all embodiments within the scope of the drawings and these descriptions are made according to such exemplary dimensions. The drawings are not made necessarily to scale. Thus, not all embodiments within the scope of the drawings and these descriptions are made according to the apparent scale of the drawings with regard to relative dimensions in the drawings. However, for each drawing, at least one embodiment is made according to the apparent relative scale of the drawing.

Like reference numbers used throughout the drawings depict like or similar elements. Unless described or implied as exclusive alternatives, features throughout the drawings and descriptions should be taken as cumulative, such that features expressly associated with some particular embodiments can be combined with other embodiments.

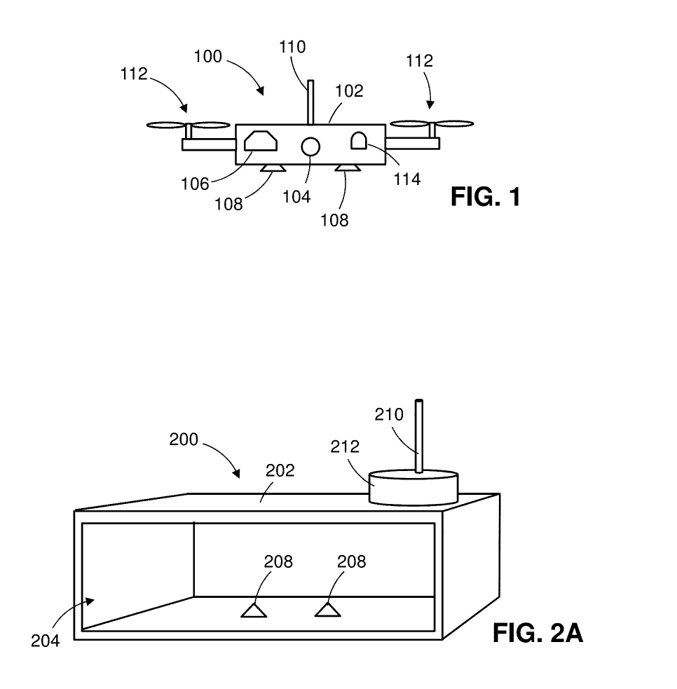

FIG. 1 shows an unmanned vehicle (UMV) referenced herein as a drone 100, according to at least one embodiment. The drone 100 includes a vehicle frame or body 102 that carries sensing elements including a camera 104 and a sonar device 106 in the illustrated embodiment. The sonar device may act as a primary navigation sensor, and may be combined with GPS device for drone 100 locating and navigating.

The antenna 110 shown extending upward from the body 102 represents various antenna arrangements including internally and externally placed antennas for sending wireless signals to convey data and receiving wireless signals for external control and onboard system updates. The drone 100 travels airborne by use of propellers 112 driven by onboard motors. Stabilization and leveling are provided automatically by an onboard controller. The drone 100 in the illustrated embodiment includes an audio system 114 that includes one or more each or a microphone and a speaker for sound input and output. The drone 100 may have any number of directional cameras and microphones so as to monitor in multiple directions at once. For example, the drone 100 may have four cameras directed at ninety-degree intervals to collect and stream 360 degree image and video data.

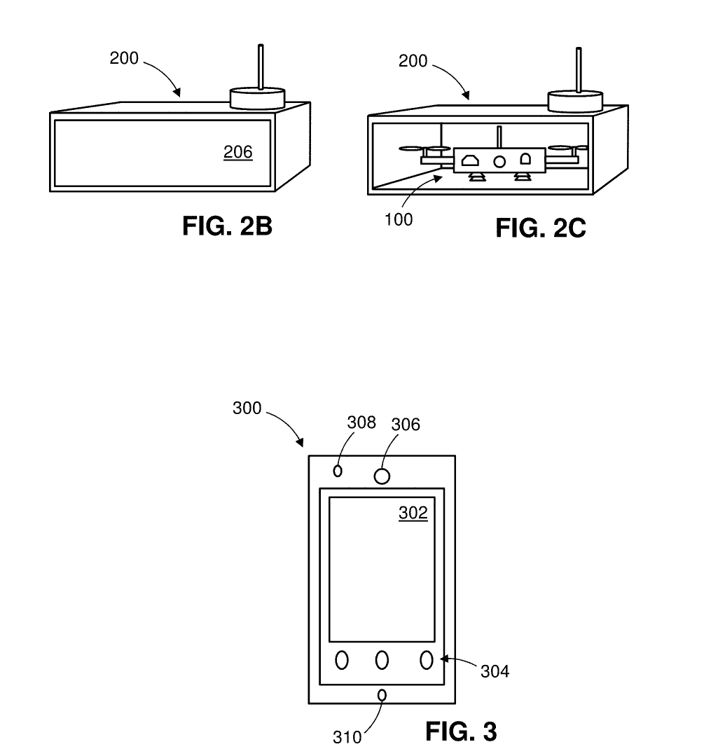

FIG. 2A is a perspective view of a hangar or base 200 for the drone 100 of FIG. 1, according to at least one embodiment. The base 200 is illustrated for purposes of non-limiting example as having a rectangular housing 202 and an internal space 204, which is accessible for entry and exit of the drone 100 when a forward door 206 (FIG. 2B) is in an open configuration (FIGS. 2A, 2C). When the door 206 is in a closed configuration, the internal space 204 is shielded from elements such as weather and other external conditions for safe storage of the drone 100 when not otherwise deployed.

The base 200 includes at least one docking element 208 for engaging the drone 100 mechanically and electrically. The docking elements 208 are illustrated in FIG. 2A for purposes of non-limiting example as extending into the internal space 204 from the floor of the base 200 to engage and corresponding docking elements 108 of the drone 100. When the drone 100 is hangered in the base 200 as shown in FIG. 2C, the docking elements 108 of the drone 100 engage the docking elements 208 of the base 200, thereby electrically connecting the drone 100 to the base 200 at least for recharging, and optionally for one-way for two-way data exchange according to various embodiments. The base 200 advantageously charges an on-board battery of the drone 100 without separation of the battery from the vehicle body 102.

The antenna 210 shown extending upward from the housing 202 of the base 200 in FIGS. 2A-2C represents various antenna arrangements including internally and externally placed antennas for sending and receiving wireless signals by which the base 200 and drone 100 communicate in some embodiments. A controller 212 of the base 200 is represented as encased by a sub-housing mounted externally on the housing 202. The controller 212 in other embodiments is internal within the housing 102 the base 200. This and other arrangement and placement features shown in the drawings serve as non-limiting examples that can vary in other embodiments within the scope of these descriptions.

FIG. 3 shows a mobile computing device 300 for use in monitoring and controlling the drone 100 of FIG. 1 and optionally base 200 of FIG. 3. The mobile device 300 can be, for example, a smart phone or other computing device having user input capabilities and communication network access. The computing device 300 can also be a desktop or tower computer, a mobile tablet, PDA, pocket PC or other type of device. The mobile device includes a display 302, which may be touch-sensitive for user input, user-input keys 304, a camera 306, an audio output device 308 such as a speaker, and an audio input device 310 such as a microphone. Communication with and control of the drone 100 by the mobile device 300 may be conducted directly or may utilize an intermediary network or device.

The drone 100 (FIG. 1) in at least one embodiment is able to alert a user via a mobile app operating on the mobile device 300. The user interface is software based and can run on Android, Windows, Linux and other operating systems. From simple directives from the user, the software derives complex command sequences. The user is provided access from anywhere a data connection is available.

In at least one embodiment, the drone 100 is an airborne travel capable vehicle with obstacle avoidance sensors, day and/or night vision camera(s) 104, and a speaker and microphone. The drone has the ability to sense, navigate into, and land inside the base 200. The base 200, for example, may be mounted on the side of a wall of a house or building, or could be on top of a building in the case of a business. In at least one embodiment, the base 200 is attached on top of or to the side of a home, office building, or other facility structure. For example, the base 200 may be mounted to the side of the building approximately 15 feet (5 m) from the ground. The base 200 may contain a sensor module, which provides a navigation aid for the drone 100 to enter and land. The base 200 automatically recharges the drone 100 either by wireless charging or by respective contact plates mounted on the docking elements 108 of the drone 100 and docking elements 208 of the base 200.

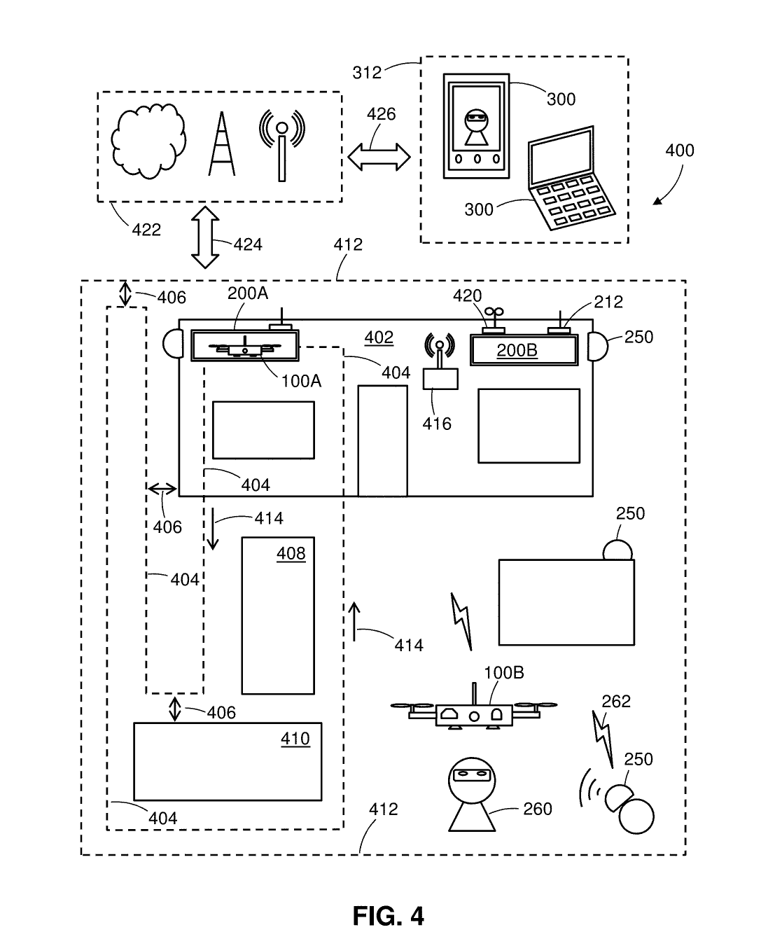

The drone 100 is an unmanned autonomous aerial craft residing in the base 200 when not airborne. While in the base 200, the drone 100 charges its batteries and monitors motion sensors 250, as shown in FIG. 4, arranged around a facility structure 402 such as a building. The motion sensors 250 may, for example, turn on flood lights, and can be activated by motion detection, for example via video.

FIG. 4 is a diagrammatic representation of a security system 400 in use at a user facility, according to at least one embodiment. Two drones 100A and 100B are shown for example in FIG. 4, each according the drone 100 embodiment of FIG. 1. Any number of drones 100 are within the scope of these descriptions. For hangar and recharging purposes, each drone 100A and 100B in FIG. 4 is associated with a dedicated respective base 200A and 200B, each of which is according the base 200 embodiment of FIGS. 2A-2C. Each base may communicate with networked local motion sensors. The drone security system is easily integrated into a customer's property, needing only a power supply and Wi-Fi connection. The network provides constant Wi-Fi connection to the drone vehicle and local sensors, provides internet access, provides private access to offsite servers for resource-hungry video processing, and subscription-based service and access.

Each drone 100A and 100B may be automatically deployed from its hangar 200A and 200B at scheduled or periodic times to follow a particular respective patrol route. A particular patrol route 404 for the hangered drone 100A is shown in FIG. 4. At a scheduled or prompted time, the drone 100A will exit the base 200A and travel the patrol route 404, maintaining a minimum offset distance 406 from the facility structure 402 and other obstacles 408, structures 410 and boundaries 412. The off-set distance 406 may be pre-programmed by the user and may be a common distance for all objects and boundaries in a patrol route 404, or may vary according to user presets or other conditions.

In at least one example, an installation technician or user can designate the patrol route 404 for the drone 100A to fly and the schedule for timed flights. A patrol route and other flight paths may include path segments in three dimensions so as to cause the drone to change its geographical ground position and its altitude. A flight path can be designated to fly the drone over and around buildings and other structures. Where two structures are too close together to permit safe flight between them, for example as represented in FIG. 4 for the obstacle 408 and structure 410, the drone 100A would fly around the area of the two structures or even over the area. Upon completing the patrol route 404, the drone 100A will return to its base 200A to be hangered and recharged. A patrol route 404 has an associated forward route direction 414 relative to any current segment of the route. Thus, travel along the patrol route 404 in the forward route direction 414 advances the drone 100A from its starting position at the base 200A and ultimately returns the drone 100A to the base 200A.

A patrol route is thus a preset flight path, which may be over or around a residential or business property, but the patrol route can be any pre-defined path. In at least one example, a default setting for the offset distance 406 may be ten feet from each building, obstacle and boundary, which may for example be defined by a fence or property line. The patrol route will also be designed taking the Federal Aviation Administration's location and altitude restrictions into consideration. A patrol route or flight path may be designed to include rotation and hovering, for example at particular locations and times, or at random intervals and locations.

In at least one embodiment, a drone completes two circuits of its patrol route and captures sound and video from one or more cameras and microphones onboard. After two circuits, the drone may land back in its base. The user, who is alerted remotely, may have the option of instructing the drone to continue a circuit via manual operation. A drone can travel directly to the area where a sensor is activated, or may travel along its patrol route or other preset flight path until reaching the area. The drone may then orbit the area slowly, or go into hover mode while a user is alerted. The drone can then continue or return to a preset flight path, for example if the user does not answer after a predetermined amount of time (e.g. 30 seconds), or the user can control the drone remotely or command it to traverse along the patrol route. The user can direct the drone to pause (hover), go forward, or go backwards along the patrol route or other flight path. The user may also instruct the drone to rotate right or left so as to image an entire area surrounding the drone. In an embodiment having multiple cameras, a surround view may be provided without drone rotation.

The drone 100B in FIG. 4 can be designated a separate patrol route according to user preferences. In FIG. 4 however, the drone 100B is shown as deployed from its base 200B in response to a sensor 250 that is distant from the base 200A within the boundary 412. As represented in FIG. 4, when a motion sensor 250 detects motion or activity, such as from a person 260 walking, a vehicle driving, or other activity within range of the sensor, the sensor sends a signal 262 to the base 200B or drone 100B. The signal may be transmitted by wire or wirelessly, and may utilize both wired and wireless connectivity. In response to the signal 262, the drone 100B can automatically launch from the base 200B and navigate to the disturbance location where activity is detected, capturing video in the process. In the event that the drone 100B is already in flight along its patrol route, the drone 100B may continue along its patrol route until reaching the approximate location of the disturbance, or the drone 100B may take a more direct flight path departing from the patrol route.

When the drone 100B approaches the person 260, an automatic voice recording may play over the onboard audio system with a predetermined message, such as “Welcome. Please proceed to the designated receiving area.” Or if after hours, the drone may sound “This is a restricted area and you are being recorded on video which is being automatically streamed and stored offsite.”

As the drone 100B is directed to the disturbance location, the drone may (for example via Wi-Fi) send an alert to a human user at a user location 312 using a user device such as the mobile device 300 or other computing device 320, such as a laptop or desktop or other computer having the same or similar connectivity and computing capabilities as the mobile device 300. The user location 312 may be within the boundary 412 or remote therefrom. The user can choose to view the live images or video, with audio content as well, or ignore.

A network arrangement 422 is shown in FIG. 4 as conveying two-way communications 424 and 426 between the user devices and the on-site devices of the system 400. The network arrangement can include any and all of the internet, a tower-based telecommunications network, and Wi-Fi as graphically represented. Other network types and devices are within the scope of these descriptions.

Video may be simultaneously captured from the drone and sent to a cloud-based DVR or other storage medium. The real time video feed from a drone to a cloud based DVR or other recording medium facilitates the ability to have a drone automatically operate based on motion detectors (video-based motion or sensor based motion).

Many features of the drone security system are new and advantageous. The autonomous flight on a preset patrol route in the air that a user need not modify in real time is unique and advantageous. Once the preset route is defined for the vehicle, the drone can additionally fly at the pre-determined offset from any given obstacle, so the shapes of buildings and other structures the drone circumnavigates are accommodated, along with any trees or other obstacles nearby. If new obstacles are placed along a predefined route, the drone simply associates or sums close lying obstacles together into one defined object to circumnavigate.

That the drone and base security system can operate over Wi-Fi as opposed to standard radio control for aircraft is advantageous in such embodiments. Although Wi-Fi technology has limited range, and signal strength may diminish as the drone moves away from the Wi-Fi access point, for example at the building where the base is mounted, the use of Wi-Fi brings significant new capabilities due to the increase in bandwidth of data. The use of Wi-Fi to control the drone and to have the drone transmit video is advantageous. The creation of a cloud-based recording (for example by DVR) retains collected data such as video securely. The drone output is linked wirelessly to upload collected data.

The drone can be controlled remotely by a computer in manual operation mode using a remote application. Flight is accomplished autonomously under computer control. A user has the ability to tell the drone to launch and/or land back in the base, and to tell the drone which directions to fly, and to hover. The user can also talk to people through the drone speaker via a smart phone app and hear responses from people being observed by the drone.

The drone hangar or base can include integral sensors for temperature, wind, humidity, air quality, precipitation, battery health, and signal strength. In at least one embodiment, a weather sensor module 420 (FIG. 4) is included in communication with the drone, base, or user mobile device, and measures environmental conditions such as temperature, wind speed, precipitation, humidity, etc. and reports via IP to a sensor module. In at least one embodiment, motion detectors sense motion and provide signals to the sensor module 420 as well.

In at least one embodiment, the sensor module collects data from the weather-monitoring system, motion detectors and other sensors, and provides data to the drone, which can make a decision to fly or not based on the provided data. In at least one embodiment, the drone is not directly given a command to fly. The sensor module may connect to the internet to transmit weather data. It has the ability to determine which sensor was activated and provide the signal to the drone. The sensor module may be owned by the owner/operator of the property under monitoring, or other party. In at least one embodiment, the sensor module is housed with the controller 212 or other portion of the base 200. In another embodiment, the sensor module is an on board system of the drone 100.

In at least one embodiment, an access point 416 (FIG. 4) plugs directly into an onsite router. The access point wirelessly connects quickly and easily to the drone and to the sensor module at the base. The drone will actively transmit health status to a central monitored server.

The drone hangar base 200, in at least one embodiment, will include computational elements, for example a drone hangar computer housed with the controller 212 or other portion of the base 200. Software for the drone hangar computer may run a collection of programs that can monitor the motion detection modules and analyze the data from the sensors to determine suitability of launch parameters for the drone.

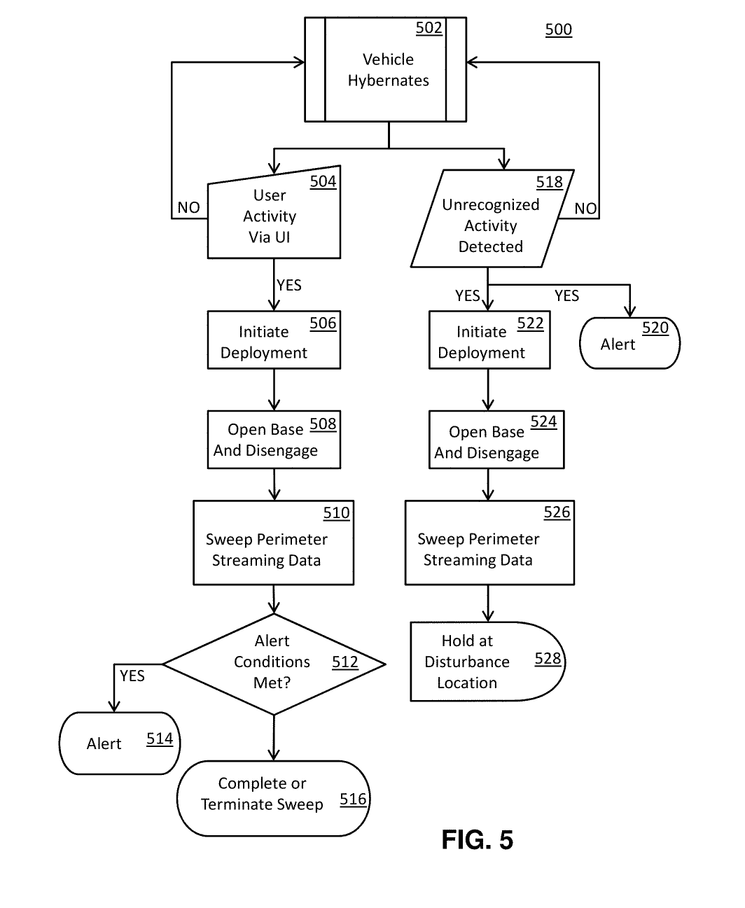

FIG. 5 is a flow chart of a method 500 of operating a drone security system according to at least one embodiment. The method 500 includes, in step 502, the drone vehicle 100 (FIG. 1) hibernating within the base station 200 (FIGS. 2A-2C), connected to the internet, charging, and awaiting deployment. The method includes detecting, at step 504, user activity at a user interface, at for example at a wireless device 300 (FIG. 3) remote from the security location. The method 500 includes, at step 506, deploying the drone vehicle when prompted by user action, and at step 508, opening the base station shell and disengaging the drone vehicle from the charger. The method includes, at step 510, sweeping a perimeter by traveling a patrol route, maintaining a pre-defined distance between the drone vehicle and a building or other structure where appropriate, while streaming video to the user. The method includes, at step 512, determining whether any of the user's alert conditions are met. If a user's predefined condition is met in step 512, for example evidence of foul play or tampering is detected, the method includes, in step 514, alerting the user and law enforcement. If a user's predefined conditions are not met in step 512, in step 516, the drone continues its sweep. The sweep continues for a user's desired time or other user-defined patrol conditions are met, for example until two passes of the patrol route circumnavigating a building or other structure perimeter are completed or until the user dismisses the sweep. After steps 514 or 516, the method returns to step 502 by return of the drone vehicle to the base.

In an alternative branch of activity, beginning again at hibernating/charging step 502, the method 500 includes, in step 518, detecting unrecognized activity via sensors, for example motion may be detected. After detecting unrecognized activity in step 518, the method includes, in step 520, alerting the user and law enforcement officials or systems, and in step 522, deploying the drone vehicle by opening the base station shell and disengaging the drone vehicle from the charger in step 524. The method then includes, at step 526, sweeping a perimeter by traveling a patrol route, maintaining a pre-defined distance between the drone vehicle and a building or other structure where appropriate, while streaming video to the user and law enforcement officials or systems. Servers may have recognition intelligence to determine where a person is detected. The method then includes, at step 528, holding the position of the drone once reaching the location of the disturbance that prompted the launch. The return of the drone to base is ultimately then prompted by user or law enforcement dismissal, or low-battery warning.

Manual Operation—In at least one embodiment, manual operation of the drone 100 via user input, for example using a mobile app on a smart device, is conducted using the following commands. These features are to be considered cumulatively without restriction or limitation. That is, each one of various embodiments may have any and all of these features.

Launch/Return commands in manual operation include:
Launch Causes the drone to take off from the base and start along the patrol route (for example, the drone may complete two circuits and return to the base).
Return Causes the drone to return to and land in the base regardless of where it is along the patrol route
Forward or Reverse Patrol Route Motion commands in manual operation include:
Fly forward Flies forward along the pre-determined patrol route—which may be 5 to 10 feet for example from a building being circumnavigated or over the top of the building. The default orientation may be the forward route direction, but if the user selects a different orientation, it will face a selected direction, and still follow the patrol route in a forward travel sense.
Fly back Flies the reverse path along the patrol route opposite the forward route direction.
Pause The drone stops all forward or reverse motion and hovers in place.

Video Interface commands in manual operation include:
Live Stream This may be the default where live video, sound and any other data from the drone is transmitted to online/cloud storage and is sent, with minimal latency, to a user device, such as the handheld smart phone mobile device 300.
Pause Pauses the video live stream or playback. (Not to be confused with pausing the vehicle in flight.)
Rewind Rewinds the live or video being played back.
Fast Forward During playback, moves the video being played forward in time.
Talk/Alarm/Alert commands in manual operation include:
Intercom Pressing this button opens an audio line from the user app to the drone speaker. When the user speaks into their smart phone, their voice is broadcast through the drone.
Mute Disables the sound on the app, in both directions. Mutes the sound on the mobile app, both the audio going from the smart device to the drone and the audio from the drone to the smart device.
Alarm Causes the drone to sound a pre-selected loud alarm sound or other-user defined alarm sound.
911 Dials police local to the security site, which may or may not be local to the user location, to whom the user can then talk.

Image Save commands in manual operation include:
Screen Capture When the video pause button is pressed this button appears as an option. If selected it takes a screen image of the video display and saves to the local smart device storage.

A Settings Menu, for example a pop up menu, may have the following options:
Save video If selected, saves/downloads the video to a local device.
Change audio alert This opens up a sub menu and allows a user to select a sound file to play at a given alert (either a sound file provided by the user or a predefined recording) or none to remain silent.
On launch based on motion detection Options allow the user to set one sound for all times of day/night, mute by time (e.g. after 9 PM play no sound); or play different sounds for different times of day/night.
On launch based on user activation Options allow the user to set one sound for all times of day/night, mute by time (e.g. after 9 PM play no sound); or play different sounds for different times of day/night.
Alarm Default is a loud alert sound. Options include any sound file the user wants to upload.

Remote Video Capture: The video in at least one embodiment is uploaded via high speed Wi-Fi from the drone to a remote server or storage, working for example as a remote DVR system. The user has the ability to log into this remote storage via a smart phone/device app or through a web-based portal on a PC/Mac. The user can download videos, erase video, and/or view them with standard playback menu available. For example, the amount of data stored may depend on the user account type or service level purchased.

Variations/Features: In at least one embodiment, a mood of the drone is displayed, for example digitally on a display screen, as a face on the front of the drone (frowning, angry, happy, welcoming etc.). The moods can be toggled by the user remotely or responses can be pre-programmed when certain events happen. The user can also take a picture of himself or herself, their favorite pet, etc. to be used as the face or a part of the appearance of the drone. The drone or base can also emit pre-recorded sounds, such as a dog barking when the drone first takes off to pursue the motion detection for example. The drone of the base can also emit a variety of lights or light patterns which the user can customize as desired for an entertaining, intimidating, or other desired effect. The drone in at least one embodiment can display video and play sounds for any purpose desired by the user, including entertainment. The owner can create a personality for the drone. The drone can, for example, record video and/or audio for playback or uploading to social media.

Options/Packages: Health Monitoring—ongoing monitoring service of the health status of the drone may be provided. In at least one embodiment, the drone sends health status reports at a regular rate and a technician will automatically be dispatched if there is a report by the drone or base of any health issues necessitating repairs.

Various service/subscription packages may be provided. Video and other data storage capacity limits may be in increased according to price schedule. License fees may apply for use of the mobile app and web interface. In one example, if the subscription is ended, data is not delivered to the drone and it will not fly. This is similar to ending a mobile phone agreement and shutting off a phone's connection to a network.

A drone security system according to these descriptions may be useful to a homeowner for use in home security. The drone may be used by stand-alone businesses. Variants can include indoor use (warehouse security etc.) and outdoor use systems. A security fence may have Wi-Fi access points placed along the fence perimeter. The drone can fly a perimeter so long as access points are in Wi-Fi range.

A security drone may be used to monitor children playing in a backyard as a drone hovers in one spot allowing parents to monitor remotely. Pets may be monitored as well. A drone security system may be used in pest deterrence, for example to chase deer away from gardens at night or other times.

A geofence may be defined to ensure the drone vehicle does not exit an intended area, such as a customer's land or rise above a pre-set altitude. The geofence is programmable, having multiple parameters that can be defined by the user to tailor the performance of the system to user-specific needs. For example, a geofence can be defined along the boundary 412 in FIG. 4. In such an example, a drone 100A or 100B may be configured to pause or reverse upon reaching the geofence. This pause or reverse feature may even override direct user control commands. In another option, the user may be alerted that the geofence is reached and given the option to pass the geofence, for example by additional user commands or by entering an authorization code. These defined geofences will meet the Federal Aviation Administration's zone restrictions.

Additional functional features are provided by the drone security system 400 (FIG. 4) according to at least one embodiment. In at least one embodiment, standing orders include: constantly monitoring the network for direct orders from the user interface; constantly monitoring local sensors; monitoring and maintaining vehicle battery health; and monitoring and maintaining the network connection.

In at least one embodiment, conditions for deployment include: direct orders from a user; local sensor data meets user pre-defined criteria; and/or dispatch by law enforcement, for example in cases of emergency.

In at least one embodiment, upon deployment of the drone vehicle from the base, the drone vehicle disengages physical coupling with the base or ground station while maintaining wireless connection via Wi-Fi, Bluetooth or other wireless connection. Ultrasonic sensors (sonar) help the drone vehicle stay approximately a predetermined distance from a building or other structure under security observation, and the drone vehicles sweeps the building or structure perimeter and uses GPS to determine position along the pre-defined route.

In at least one embodiment, the drone vehicle returns to base when released by a user, when released by law enforcement officials, or when an autonomous itinerary or task is complete. Servo motors open the base station hull and expose physical and electrical contacts for the vehicle to couple with for storage and recharging. In at least one option, the base is an open system with no door but has an overhang protecting the vehicle. The overhang is an alternative approach where climate or weather is not an issue.

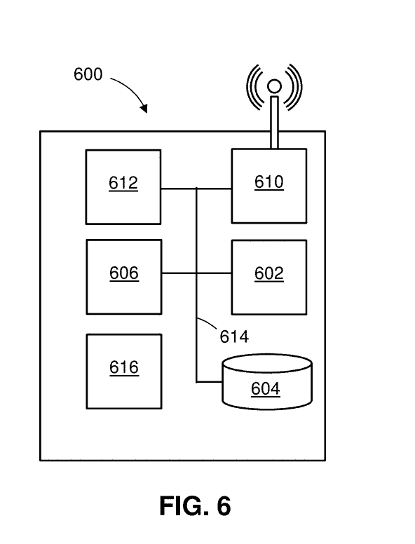

FIG. 6 is a diagrammatic representation of a computing device 600 of which the above-described mobile device 300 may be an example. The computing device 600 includes components such as a processor 602, and a storage device or memory 604. A communications controller 606 facilitates data input and output to a radio 610. Input and output devices 612 such as a screen and keyboard or other buttons facilitate interface with a user. Examples of input and output devices 612 include, but are not limited to, alphanumeric input devices, mice, electronic styluses, display units, touch screens, signal generation devices (e.g., speakers) or printers, and microphones. A system bus 614 or other link interconnects the components of the computing device 600. A power supply 616, which may be a battery or voltage device plugged into a wall or other outlet, powers the computing device 600 and its onboard components.

By way of example, and not limitation, the processor 602 may be a general-purpose microprocessor such as a central processing unit (CPU), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated or transistor logic, discrete hardware components, or any other suitable entity or combinations thereof that can perform calculations, process instructions for execution, and other manipulations of information.

The storage device or memory 604 may include, but is not limited to: volatile and non-volatile media such as cache, RAM, ROM, EPROM, EEPROM, FLASH memory or other solid state memory technology, disks or discs or other optical or magnetic storage devices, or any other medium that can be used to store computer readable instructions and which can be accessed by the processor 602. In at least one example, the storage device or memory 604 represents a non-transitory medium upon which computer readable instructions are stored. For example, a user downloads and runs software for the mobile application described herein, or updates thereof, from an online source such as a digital content store.

Aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present invention may be written in any combination of one or more programming languages, including an object-oriented programming language such as Java, Python, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter example, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or diagrams, and combinations of blocks in the flowchart illustrations and/or diagrams, can be implemented or facilitated by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or diagrams.

The flowchart and diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. It is to be understood that these descriptions are not limited to any single embodiment or any particular set of features, and that similar embodiments and features may arise or modifications and additions may be made without departing from the scope of these descriptions and the spirit of the appended claims.

What is claimed is:

1. A method of operating a drone security system, the method comprising:
engaging a drone with a base;
receiving signals from at least one sensor remote from the drone vehicle and base;
detecting activity;
disengaging the drone vehicle from the base;
traveling by the drone vehicle;
collecting, by the drone vehicle, data including at least one of video, audio, and sensor data; and
transmitting, by the drone, the collected data.

2. The method of claim 1, wherein detecting activity comprises receiving a user command signal prompted by activity of a user at a user interface.

3. The method of claim 2, wherein transmitting the collected data comprises streaming video to the user interface for viewing by the user.

4. The method of claim 3, wherein traveling by the drone vehicle comprises at least intermittently traveling according to user command signals.

5. The method of claim 1, wherein detecting activity comprises determining unrecognized activity via the received signals from the at least one sensor.

6. The method of claim 5, wherein traveling by the drone vehicle comprises traveling to a location of the detected activity.

7. The method of claim 1, wherein traveling by the drone vehicle comprises flying.

8. A security system comprising:
a base configured to house and charge a drone vehicle;
a drone vehicle configured to engage with the base; and
at least one sensor in electrical communication with the drone vehicle,
wherein the drone is configured for:
receiving signals from the at least one sensor;
detecting activity;
disengaging from the base;
traveling;
collecting data including at least one of video, audio, and sensor data; and
transmitting the collected data.

9. The security system of claim 8, wherein detecting activity comprises receiving a user command signal prompted by activity of a user at a user interface.

10. The security system of claim 9, wherein transmitting the collected data comprises streaming video to the user interface for viewing by the user.

11. The security system of claim 10, wherein traveling by the drone vehicle comprises at least intermittently traveling according to user command signals.

12. The security system of claim 8, wherein detecting activity comprises determining unrecognized activity via the received signals from the at least one sensor.

13. The security system of claim 12, wherein traveling comprises traveling to a location of the detected activity.

14. The security system of claim 8, wherein traveling comprises flying.

15. The security system of claim 14, wherein the drone vehicle is configured to fly along a preset flight path.

16. The security system of claim 15, wherein a user cannot change the preset flight path in real time.

17. The security system of claim 8, wherein the drone displays an image.

18. The security system of claim 8, wherein the drone plays a sound upon alert.

19. The security system of claim 8, wherein the drone is configured to facilitate two-way communication between a user and a person under observation.

20. The security system of claim 8, wherein the drone is configured to facilitate a conversation between a user and a person under observation.
